(19) United States
(12) Patent Application Publication
(10) Pub. No.: US 2006/0288198 A1
(43) Pub. Date: Dec. 21, 2006

(54) Data storage system and related method

(75) Inventors: Wh Shih, Taipei (TW); Chin-Fong Pan, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/257,608

(22) Filed: Oct. 24, 2005

(30) Foreign Application Priority Data
Jun. 15, 2005 (TW) 094119777

(51) Int. Cl. G06F 15/177

(52) U.S. Cl. 713/1

(57) ABSTRACT

A data storage system and method is proposed for use with computer systems having a BIOS program. The data storage system includes a power-on setting parameter storage area adapted for storing power-on setting parameters for allowing the BIOS program to read the required parameters and run a POST procedure on starting the computer system; and a backup data storage area for generating a copy of power-on setting parameters stored in the power-on setting parameter storage area, and the stored power-on setting parameters will be updated according to changes made on the power-on setting parameters, such that in cases where the BIOS program is unable to run the POST procedure according to the stored power-on setting parameters, the updated power-on setting parameters stored in the backup data storage area can be used for running the POST procedure, thereby enabling the computer system to start and operate normally.

### BACKGROUND OF THE INVENTION

1. Field of the Invention

This invention relates to a data storage technique, and more particularly, to a data storage system and related method capable of saving power-on setting parameters safely.

2. Description of Related Art

With the explosive development of information technology, a computer system having more powerful functions comes to the market and becomes one of the most evitable electronic apparatuses in daily life.

A conventional computer system, such as a personal computer, a notebook computer and a server, has a basic input/output system (hereinafter BIOS in brief) stored in a BIOS memory, a kind of storage media such as a read-only memory (ROM), an erasable programmable read-only memory (EPROM) or an electrically erasable programmable read-only memory (EEPROM), all of which are installed on a motherboard. The BIOS enables the computer system to determine peripheral hardware devices attached to the computer system, and controls the operations of the computer system and the peripheral hardware devices. Since the BIOS is an essential program for a computer system, and is a well-known art to persons skilled and familiar with computer technologies, detailed description are hereby omitted.

In addition to the BIOS memory, the computer system further comprises a power-on setting parameter memory such as a complementary metal oxide semiconductor (CMOS) memory installed also on the motherboard for storing power-on setting parameters set by a user or a computer designer. The power-on setting parameters comprise the information of a model of a hard disk, a number of magnetic tracks of an optical disk inserted into an optical disk drive, a number of sectors of a magnetic track, a number of sides of an optical disk for recording data, time and date of the computer system, a number and data storage capacity of a floppy drive, hard disk setting parameters for running a power-on procedure, mode setting parameters of a monitor, and a number of memory, all of which are updated by the BIOS. The setting parameters stored in the CMOS memory unit are operational parameters required for the computer system to run a Power-On Self Test (POST) procedure, and can be changed by the BIOS stored in the CMOS memory according to the preference of the user. However, disconnection of transmission due to unpredictable errors occurred during a test procedure (such as unstable power supply, errors occurred in system programs as well as application programs, hardware malfunctions, undue operations by users, and virus affections), might cause the CMOS to lose data or even inadvertently and seriously damage the CMOS, that in turn causes malfunctions or even impede normal operations as a result. At the worst, the computer system might not be able to carry out the POST procedure in order to start the computer system functions normally.

Whenever such a problem occurs, usually there is no other alternative but to replace a new CMOS memory unit so that the computer system can start normally but the preferences settings are unable to restore and need to be replaced.

Therefore, how to solve the problems of having impaired parameter settings caused by computer system malfunctions and then the necessity of returning such parameter settings to an original manufacturer for restoration as a result of the damage, is a critical issue to resolve.

### SUMMARY OF THE INVENTION

It is therefore an objective of this invention to provide a novel data storage system and related method, which not only can allow the BIOS program of a computer system to safely store a user's preference settings as well as the power-on parameter setting for starting a computer system that has been altered, but also can automatically generate a copy of power-on setting parameters in another memory unit, thereby preventing damages caused by system malfunctions and loss of preset parameters as a result of such breakdown by safely saving a copy of power-on setting parameters to enable the computer system to start smoothly.

To achieve the above and other objectives, the present invention provides a data storage system and related method applicable to a computer system having a BIOS program. The data storage system includes a power-on setting parameter storage area adapted for storing power-on setting parameters, the BIOS program reading the stored power-on setting parameters and running a POST procedure; and a backup data storage area for storing backup data of the power-on setting parameters stored in the power-on setting parameter storage area, backup data varying with the change of the power-on setting parameters stored in the power-on setting parameter storage area, when failing to run the POST procedure according to the power-on setting parameters stored in the power-on setting parameter storage area the BIOS running the POST procedure according to the back data stored in the back data storage area.

Accordingly, the present invention further provides a data storage method applicable to a computer system having a BIOS program. The data storage method includes establishing a power-on setting parameter storage area in the computer system for storing power-on setting parameters, the BIOS program reading the stored power-on setting parameters and running a POST procedure; establishing a backup data storage area in the computer for storing backup data of the power-on setting parameters stored in the power-on setting parameter storage area, the backup data varying with the change of the stored power-on setting parameters; and powering-on the computer system to enable the BIOS to run the POST procedure according to the power-on setting parameters stored in the power-on setting parameter storage area, or to enable the BIOS to run the backup data stored in the backup data storage area if the BIOS program fails to run the POST procedure according to the power-on setting parameters stored in the power-on setting parameter storage area.

### BRIEF DESCRIPTION OF DRAWINGS

FIG. 1 is a functional block diagram of a data storage system of the preferred embodiment according to the present invention; and

FIG. 2 is a flowchart of a data storage method corresponding to the data storage system shown in FIG. 1 according to the present invention.

### DETAILED DESCRIPTION OF PREFERRED EMBODIMENTS

The following description contains specific information pertaining to the implementation of the present invention. One skilled in the art will readily recognize other advantages and features of the present invention after reviewing what specifically disclosed in the present application. It is manifest that the present invention can be implemented and applied in a manner different from that specifically discussed in the present application. It should also be understood that the invention is not limited to the particular exemplary embodiments described herein, but is capable of many rearrangements, modifications, and substitutions without departing from the spirit of the present invention. Wherein, attention that the drawings according to the present invention are all simplified schematic diagrams should be paid to, i.e., they merely illustrate the components pertaining to the invention, and it is not limited to the components what illustrated, the number of the components, shape or proportion of size when actually implementing is a selective design, the layout of the component may be more complex.

The following embodiment further describes the technique means of the present invention in detail, but it is not used to limit the scope of the present invention.

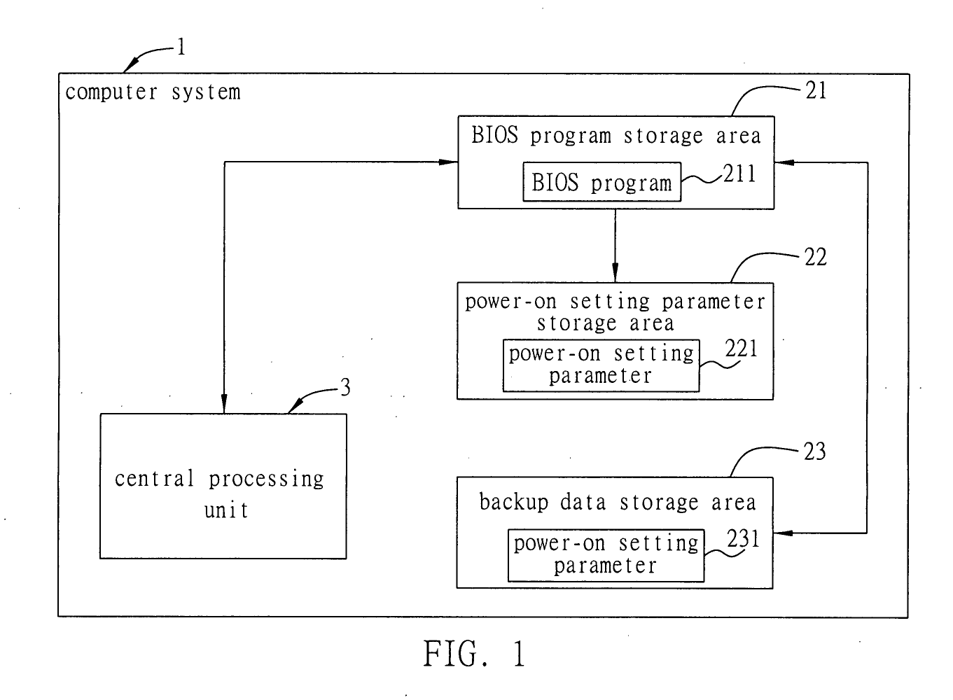

FIG. 1 is a functional block diagram of a data storage system of the preferred embodiment according to the invention. As shown in FIG. 1, the data storage system is applied to a computer system 1 which at least comprises a central processing unit (CPU) 3, a BIOS program storage area 21, a power-on setting parameters storage area 22, and a backup data storage area 23. Note that the computer system 1 further comprises other elements such as a south bridge chip, a north bridge chip, an input/output control chip and so on, and the drawing shows the parts related to the invention only for brevity.

As a control center of the computer system 1, the CPU 3 controls the overall operations of the computer system 1.

The BIOS program storage area 21 is used to pre-store a BIOS program 211. The BIOS program storage area 21 can be any types of memory able to be accessed directly by the CPU 3. For example, The BIOS program storage area 21 is a ROM or an EEPROM.

The power-on setting parameters storage area 22 is used to store power-on setting parameters 221 (such as the information of a model of a hard disk, a number of magnetic tracks of an optical disk inserted into an optical disk drive, a number of sectors of a magnetic track, a number of sides of an optical disk for recording data, time and date of the computer system, a number and data storage capacity of a floppy drive, hard disk setting parameters for running a power-on procedure, mode setting parameters of a monitor, and a number of memory) required for the computer system 1 to operate. The power-on setting parameters stored in the power-on setting parameters storage area 22, which can be a CMOS memory, can be set by a manufacturer designing or manufacturing the computer system 1 or by a user according to his preference. The information and data stored in the BIOS program storage area 21 and the power-on setting parameter storage area 22 ensure the computer system 1 to run the POST procedure and to complete a power-on procedure successfully. Since the CPU 3 is a necessary component for the computer system 1, and BIOS-related information and data are also a well-known art, further descriptions hereby omitted for brevity.

The backup data storage area 23 is used to store backup data of the power-on setting parameters 221 stored in the power-on setting parameters storage area 22. The backup data storage area 23 can be a Flash ROM. Note that a number of the backup data storage area 23 is not limited to one as illustrated in FIG. 1. The computer system 1 can comprise two or more backup data storage area depending on practical uses.

When powered-on, the computer system 1 runs the BIOS program 211 stored in the BIOS program storage area 21 and reads the power-on setting parameters 221 stored in the power-on setting parameters storage area 22, so as to run a verification procedure on the power-on setting parameters 221. The verification procedure, which can be a Checksum or a Cyclical Redundancy Check method, verifies whether the power-on setting parameters 231 stored in the backup data storage area 23 are matched with the power-on setting parameters 221 stored in the power-on setting parameters storage area 22; if the power-on setting parameters 231 stored in the backup data storage area 23 are matched with the power-on setting parameters 221 stored in the power-on setting parameters storage area 22, the verification procedure reports correct, and the power-on setting parameters 221 stored in the power-on setting parameters storage area 22 can be used to run the POST procedure accordingly; otherwise, if the power-on setting parameters 231 stored in the backup data storage area 23 are not matched with the power-on setting parameters 221 stored in the power-on setting parameters storage area 22, the verification procedure is failed and the POST procedure is unable to be carried out, this means unusual problems has occurred in the computer system 1. Generally such unusual problems are mostly caused by the impaired power-on setting parameters 221 stored in the power-on setting parameters storage area 22 that are unable to allow the BIOS program 211 to execute POST procedure accordingly. The BIOS program 211 then reads the power-on setting parameters 231 stored in the backup data storage area 23 automatically and runs the POST procedure again. In the same time, the BIOS program 211 copies the power-on setting parameters 231 stored in the backup data storage area 23 to the power-on setting parameter storage area 22 to replace the ruined power-on setting parameters 221. When powered on again this time or next time, the computer system 1 enables the BIOS program 211 to run the POST procedure according to the preference settings made by the user, so as to ensure smooth operations of the computer system after it is powered-on.

Therefore, the data storage system disclosed by the present invention not only can overcome the problem of the impaired power-on setting parameters 221 stored in the power-on setting parameter storage area 22 that hinders the computer system from starting smoothly, but also can safely save the preference setting parameters made by the user, thereby effectively eliminating the trouble of having to reset power-on setting parameters whenever an usual problem arouse from the computer system 1.

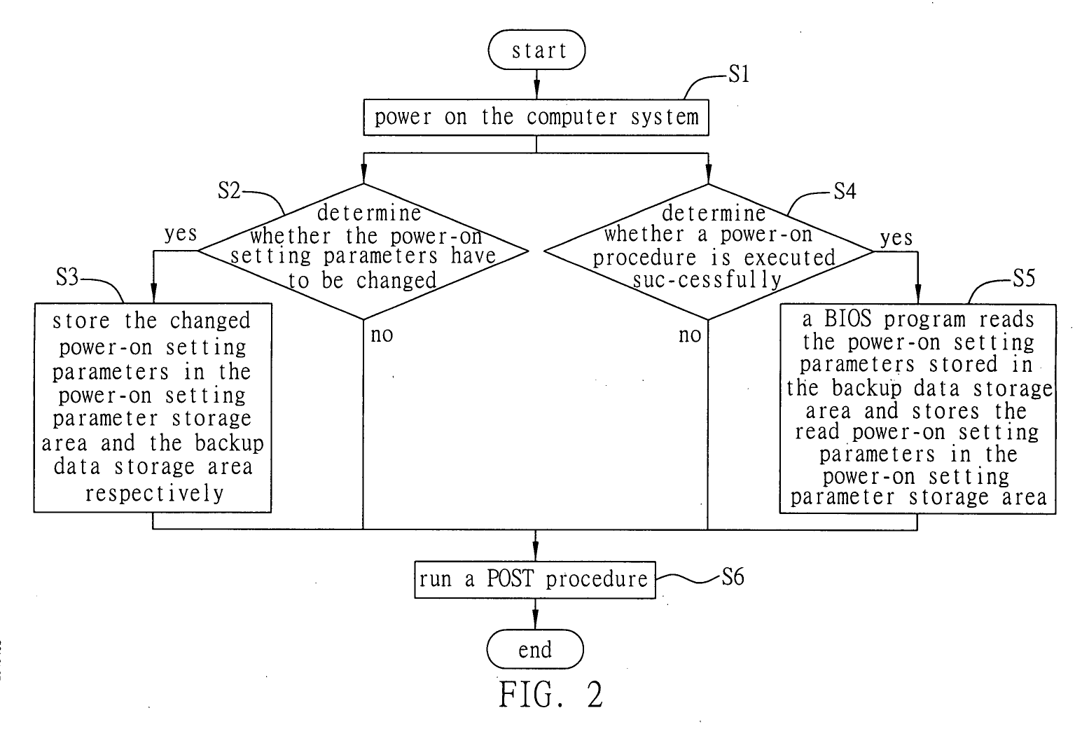

FIG. 2 is a flowchart of a data storage method corresponding to the data storage system according to the present invention. Before the data storage method is executed, the backup data storage area 23 (such as a Flash ROM) has to be established in the computer system 1 for storing backup data of the power-on setting parameters 231 set by the user. The data storage method starts in step S1. In step S, the computer system 1 is powered-on by a user, for example, to press a power switch or a reset switch, and the POST and the BIOS program 211 stored in the BIOS program storage area 21 are run sequentially. Then, step S2 and step S4 are executed respectively.

In step S2, which is executed after step S1, during the power-on procedure the BIOS program 211 determines whether the power-on setting parameters should be changed. In other words, the BIOS program 211 determines whether a user has entered a setting image displayed on a monitor, input power-on setting parameters, and input a verification instruction “save”.

In step S3, which is executed after step S2, the BIOS program 211 saves the power-on setting parameters in the BIOS program storage area 21 and the backup data storage area 23 respectively. Then, step S6 is executed.

In step S4, during the power-on procedure the BIOS program 211 first runs the verification procedure on the power-on parameters with the above-mentioned Checksum or Cyclical Redundancy Check methods for example to determine whether the power-on setting parameters 231 stored in the backup data storage area 23 are consistent with the power-on setting parameters 221 stored in the power-on setting parameter storage area 22. If the power-on setting parameters 231 stored in the backup data storage area 23 are consistent with the power-on setting parameters 221 stored in the power-on setting parameter storage area 22, the verification procedure is correct and step S6 is to be executed; otherwise, if the power-on setting parameters 231 stored in the backup data storage area 23 are not consistent with the power-on setting parameters 221 stored in the power-on setting parameter storage area 22, the verification procedure is failed and step S5 is to be executed.

In step S5, the BIOS program 211 reads the power-on setting parameters 231 stored in the backup data storage area 23 and further saves the power-on setting parameters 231 in the power-on setting parameter storage area 22. The power-on setting parameters 221 previously stored in the power-on setting parameter storage area 22 are covered and replaced by the power-on setting parameters 231, so as to delete the impaired data. Thereafter, step S6 is executed.

In step S6, the BIOS program 211 runs the POST procedure according to the power-on setting parameters 231 stored in the power-on setting parameter storage area 22 to complete the power-on procedure.

In addition, note that in step S4 of the power-on procedure when the BIOS program 211 determines that the power-on setting parameters 221 stored in the power-on setting parameter storage area 22 are unable to be used to run the power-on procedure on the computer system 1 successfully (that is, the power-on setting parameters 231 stored in the backup data storage area 23 are not consistent with power-on setting parameters 221 stored in the power-on setting parameter storage area 22), the BIOS program 211 reads the power-on setting parameters 231 stored in the backup data storage area 23 to run the POST procedure, without having to duplicate the power-on setting parameters 231 to the power-on setting parameter storage area 22 as respectively described in the foregoing steps S5 and S6, alternatively, the BIOS program 211 can directly access the power-on setting parameter storage area 22 depending on the implementations.

In summary, the data storage system and related method according to the present invention can effectively solve the problem encountered in the prior art that cause great inconvenience to users where an unusual problem or breakdown occurs in a computer system which inadvertently causes damage to power-on setting parameters 221 and consequently hinders the computer system 1 from starting and operating normally.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A data storage system for a computer systems having a basic input output system (BIOS) program, the data storage system comprising:
a power-on setting parameter storage area for storing power-on setting parameters, the BIOS program reading the stored power-on setting parameters and running a power-on self-test (POST) procedure when the computer system is powered-on; and
a backup data storage area for storing backup data of the power-on setting parameters stored in the power-on setting parameter storage area, the backup data varying with the change of the power-on setting parameters stored in the power-on setting parameter storage area, when failing to run the POST procedure according to the power-on setting parameters stored in the power-on setting parameter storage area the BIOS running the POST procedure according to the back data stored in the back data storage area.

2. The data storage system of claim 1, wherein before running the POST procedure the BIOS further runs a changing procedure to change the power-on setting parameters stored in the power-on setting parameter storage area, and runs a varying procedure to vary the back data stored in the backup data storage area accordingly after the changed power-on setting parameters stored in the power-on setting parameter storage area are verified.

3. The data storage system of claim 1, further copying and saving the backup data stored in the backup data storage area to the power-on setting parameter storage area when the BIOS program fails to run the POST procedure according to the power-on setting parameters stored in the power-on setting parameter storage area.

4. The data storage system of claim 3, wherein the power-on setting parameters originally stored in the power-on setting parameter storage area are covered by the backup data stored in the backup data storage area.

5. The data storage system of claim 1, wherein before running the POST procedure the BIOS program further runs a verification procedure to verify if the power-on setting parameters stored in the power-on setting parameter storage area is matched with the backup data stored in the backup data storage area, and the BIOS program does not run the POST procedure unless the power-on setting parameters stored in the power-on setting parameter storage area is matched with the backup data stored in the backup data storage area.

6. The data storage system of claim 1, wherein the power-on setting parameter storage area is a complementary metal oxide semiconductor (CMOS) memory.

7. The data storage system of claim 1, wherein the backup data storage area is a Flash read-only memory (ROM).

8. A data storage method for a computer systems having a BIOS program, the data storage method comprising:
establishing a power-on setting parameter storage area in the computer system for storing power-on setting parameters, the BIOS program reading the stored power-on setting parameters and running a POST procedure when the computer system is powered-on;
establishing a backup data storage area for storing backup data of the power-on setting parameters stored in the power-on setting parameter storage area, the backup data varying with the change of the power-on setting parameters stored in the power-on setting parameter storage area; and
powering-on the computer system to enable the BIOS to run the POST procedure according to the power-on setting parameters stored in the power-on setting parameter storage area, or to enable the BIOS to run the backup data stored in the backup data storage area if the BIOS program fails to run the POST procedure according to the power-on setting parameters stored in the power-on setting parameter storage area.

9. The data storage method of claim 8, wherein before running the POST procedure the BIOS further runs a changing procedure to change the power-on setting parameters stored in the power-on setting parameter storage area, and runs a varying procedure to vary the back data stored in the backup data storage area accordingly after the changed power-on setting parameters stored in the power-on setting parameter storage area are verified.

10. The data storage method of claim 8, further copying and saving the backup data stored in the backup data storage area to the power-on setting parameter storage area when the BIOS program fails to run the POST procedure according to the power-on setting parameters stored in the power-on setting parameter storage area.

11. The data storage method of claim 10, wherein the power-on setting parameters originally stored in the power-on setting parameter storage area are covered by the backup data stored in the backup data storage area.

12. The data storage method of claim 8, wherein before running the POST procedure the BIOS program further runs a verification procedure to verify if the power-on setting parameters stored in the power-on setting parameter storage area is matched with the backup data stored in the backup data storage area, and the BIOS program does not run the POST procedure unless the power-on setting parameters stored in the power-on setting parameter storage area is matched with the backup data stored in the backup data storage area.

13. The data storage method of claim 8, wherein the power-on setting parameter storage area is a CMOS memory.

14. The data storage method of claim 8, wherein the backup data storage area is a Flash ROM.
